(19) United States
(12) Patent Application Publication
(10) Pub. No.: US 2008/0162443 A1
(43) Pub. Date: Jul. 3, 2008

(54) Method, apparatus, and computer program product for controlling query

(75) Inventors: Tatsuya Asai, Kawasaki (JP); Seishi Okamoto, Kawasaki (JP)

Correspondence Address: GREER, BURNS & CRAIN, 300 S WACKER DR, 25TH FLOOR, CHICAGO, IL, 60606, US

(73) Assignee: Fujitsu Limited, Kawasaki-shi (JP)

(21) Appl. No.: 11/903,968

(22) Filed: Sep. 25, 2007

(30) Foreign Application Priority Data
Dec. 27, 2006 (JP) 2006-353268

(51) Int. Cl. G06F 17/30

(52) U.S. Cl. 707/4; 707/E17.014

(57) ABSTRACT

A database system includes a query controller and an XML database, and is connected to other terminal devices such as a user device via a network. In such a configuration, when a query request is transmitted from the user device to the XML database, the query controller determines whether an access to a node corresponding to the query request by a user specified by user information is permitted or denied by referring to access information relative to each node stored in an access control DB, to extract an access-permitted query request, and transfers only the extracted query request to the XML database.

### BACKGROUND OF THE INVENTION

1. Field of the Invention

The present invention relates to a query control program, a query controller, and a query control method that make a computer execute transfer of a query request transmitted from a user device, which performs various types of processing, to an XML database that responds to the query request transmitted from the user device.

2. Description of the Related Art

Conventionally, various databases such as a relational database (RDB) have been proposed for storing data efficiently and performing search and update of the stored data efficiently.

Fine-grained access control has been required recently, and an XML database that can store an extensible markup language (XML) document in an original format (tree format, tree structure) attracts attention instead of RDB, which has attracted attention conventionally. Generally, the database system holds a large-capacity database (for example, XML database), and stores (holds) a large amount of data in the database. In such a database system, a user who uses data stored in the database inputs a search condition (for example, XQuery or a query request) via application software, and data that matches the search condition is provided to the user as a search result.

The XML database has been widely used in various fields such electronic transactions and the Internet, and a large-scale data is frequently handled. Therefore, various techniques for accurately and quickly responding to the XQuery (query) have been proposed for SML databases.

In XML databases, path pruning, which uses a path schema to convert a path pattern including a wild card character to a specific path, is used as a method of applying a character string search technique to the XQuery relative to the stored XML data (“A Proposal for XQuery Processor with Deterministic Automaton and Path Pruning” by Akira ISHINO and Masayuki TAKEDA, The Database Society Japan, Letters Vol. 4, No. 4). Specifically, path pruning is performed relative to an XQuery query formulation (search request) by using the path schema (path try) acquired from the XML data, to build deterministic automaton. The XML data is processed using the automaton, thereby to return the search result relative to the XQuery.

As a conventional technique, there is a technique in which the XML database having received a query request from a user temporarily reads into a memory all access control rules corresponding to the XML data to be stored, to detect an access control rule corresponding to the query request, and query processing is performed based on the access control rule to return a query response.

In the conventional technique, every time the query request (XQuery) is received from the user, the huge access control rules need to be scanned. Therefore, the query processing time since reception of the query request until return of the query response becomes long (the query processing is not performed at a high speed), and a memory area and a disk area for reading all the huge access control rules are required.

### SUMMARY OF THE INVENTION

It is an object of the present invention to at least partially solve the problems in the conventional technology.

A computer-readable recording medium according to one aspect of the present invention stores therein a computer program for transferring a query request transmitted from a user device that performs various processes to an extensible-markup-language database that responds to the query request. The computer program causing a computer to execute storing user information on the user device in association with an identifier allocated to the user device; storing user information for specifying a user whose access to a node is permitted or denied for each node of a path try corresponding to the extensible-markup-language data stored in the extensible-markup-language database; query determining/extracting including, upon receiving the identifier and the query request, acquiring user information corresponding to the identifier, determining whether an access to a node corresponding to the query request by the user specified by the user information is permitted or denied by referring to access information with respect to each stored node, and extracting a query request for which the access is permitted; and transferring the query request extracted at the query determining/extracting.

An apparatus according to another aspect of the present invention is for transferring a query request transmitted from a user device that performs various processes to an extensible-markup-language database that responds to the query request. The apparatus includes a user-information storage unit that stores user information on the user device in association with an identifier allocated to the user device; an access-control storage unit that stores user information for specifying a user whose access to a node is permitted or denied for each node of a path try corresponding to the extensible-markup-language data stored in the extensible-markup-language database; a query determining/extracting unit that, upon receiving the identifier and the query request, acquires user information corresponding to the identifier from the user-information storage unit, determines whether an access to a node corresponding to the query request by the user specified by the user information is permitted or denied by referring to access information with respect to each node stored in the access-control storage unit, and extracts a query request for which the access is permitted; and a query transfer unit that transfers the query request extracted by the query determining/extracting unit.

A method according to still another aspect of the present invention is for transferring a query request transmitted from a user device that performs various processes to an extensible-markup-language database that responds to the query request. The method includes storing user information on the user device in association with an identifier allocated to the user device; storing user information for specifying a user whose access to a node is permitted or denied for each node of a path try corresponding to the extensible-markup-language data stored in the extensible-markup-language database; query determining/extracting including, upon receiving the identifier and the query request, acquiring user information corresponding to the identifier, determining whether an access to a node corresponding to the query request by the user specified by the user information is permitted or denied by referring to access information with respect to each stored node, and extracting a query request for which the access is permitted; and transferring the query request extracted at the query determining/extracting.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram for explaining an outline and characteristics of a database system including a query controller according to a first embodiment of the present invention;

FIG. 2 is a block diagram of a configuration of the database system including the query controller according to the first embodiment;

FIG. 3 is an example of information stored in an XML database;

FIG. 4 is an example of information stored in a user information DB;

FIG. 5 is an example of information stored in an access control DB;

FIG. 6 is a flowchart for explaining a query response process in the database system according to the first embodiment;

FIG. 7 is a block diagram of a configuration of a database system including a query controller according to a second embodiment of the present invention;

FIG. 8 is an example of information that can be stored in an access control policy;

FIG. 9 is a flowchart for explaining an access-control-DB generating process in the database system according to the second embodiment;

FIG. 10 is an example in which one access control DB is generated from a plurality of XML databases; and

FIG. 11 is an example of a computer system that executes a query control program.

### DETAILED DESCRIPTION OF THE PREFERRED EMBODIMENTS

Exemplary embodiments of the present invention are explained in detail below with reference to the accompanying drawings. Main terms used in following embodiments, an outline and characteristics of a database system including a query controller according to a first embodiment of the present invention, a configuration and process procedures of the database system including the query controller according to the first embodiment, and effects of the first embodiment are sequentially explained first, and other embodiments will be explained.

Major terms used according to the first embodiment are explained first. The “database system” used according to the first embodiment is a system formed of a “query controller” and an “XML database”, which operates in cooperation with other application software, and stores target data in the application software. Generally, the database system holds a large-capacity hard disk (corresponding to the XML database according to the first embodiment), and stores (holds) a large amount of data in the hard disk. In such a database system, a user who uses data stored in the database system inputs a search condition (a query request) via the application software, and data that matches the search condition is provided to the user (user device) as a search result.

The “XML database” is a database in which the XML data can be stored in an original format. Specifically, the XML database can directly handle the XML tree structure as a data structure, and can store and use the data without accompanying schema definition, which is different from the relational database (RDB). Upon reception of a query request such as XPath or XQuery from the user device, the XML database searches the stored XML data for data that matches the query request, and provides the data to the user (user device) as a search result.

The “query controller” is an apparatus that executes a program for transferring a query request transmitted from the user device to the XML database. Specifically, the query controller receives the query request such as XPath or XQuery transmitted from the user device to the XML database system, and transfers the query request to the database system. A response to the query request is transmitted from the XML database to the user device via the query controller. According to the first embodiment, the query controller is explained for a case that the query controller is incorporated in the database system. However, the present invention is not limited thereto, and the query controller can be incorporated in another apparatus connected to the database system.

The “path try” is generally referred to as a path schema, in which when the XML data stored in the XML database is converted to a documents object model (DOM), conversion is made such that all paths appearing therein appears only once, that is, the path schema concludes a repetition structure of the XML data (a tree structure strictly including one path each).

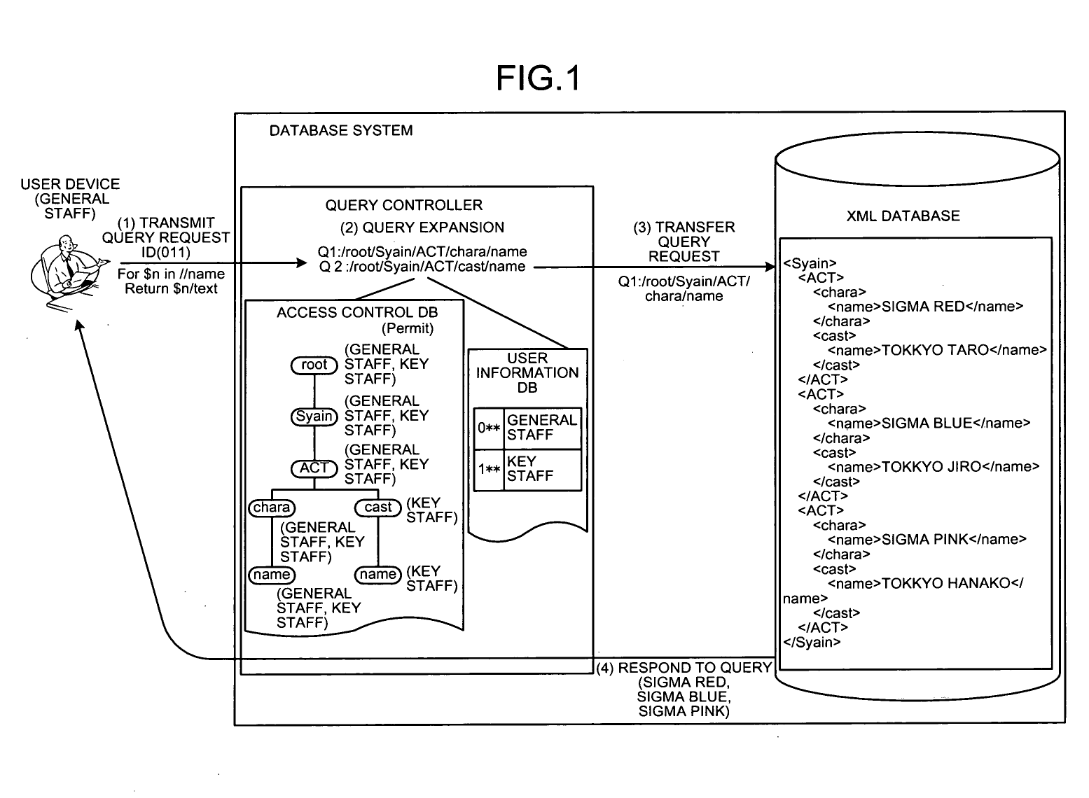

An outline and characteristics of the database system including the query controller according to the first embodiment are explained with reference to FIG. 1. FIG. 1 is a schematic diagram for explaining the outline and the characteristics of the database system including the query controller according to the first embodiment.

As shown in FIG. 1, the database system according to the first embodiment is formed of the query controller and the XML database, and is connected to other terminal devices such as user devices via the network. The XML database stores data such as “Sigma Red, Tokkyo Taro”, “Sigma Blue, Tokkyo Jiro”, and “Sigma Pink, Tokkyo Hanako” as XML data. The user device transmits a query request such as XPath or XQuery to the database system based on an instruction of the user.

According to such a configuration, the database system including the query controller according to the first embodiment transfers the query request transmitted from the user device to the XML database, which responds to the query request transmitted from the user device that performs various types of processing. Particularly, it is a main characteristic that at the time of responding to the query request, the database system can respond at a high speed and can reduce memory usage and disk usage.

The main characteristic is explained more specifically. The query controller stores user information related to the user device in a user information DB, in association with an identifier allocated to the user device. For example, “0**, general staff”, “1**, key staff” (*: wild card) are stored in the user information DB. Information including various data and parameters stored in the user information DB can be optionally changed, unless otherwise specified. For example, not only “general staff” and “key staff” are discriminated from each other, but also individual name such as “001, Suzuki Taro” can be stored.

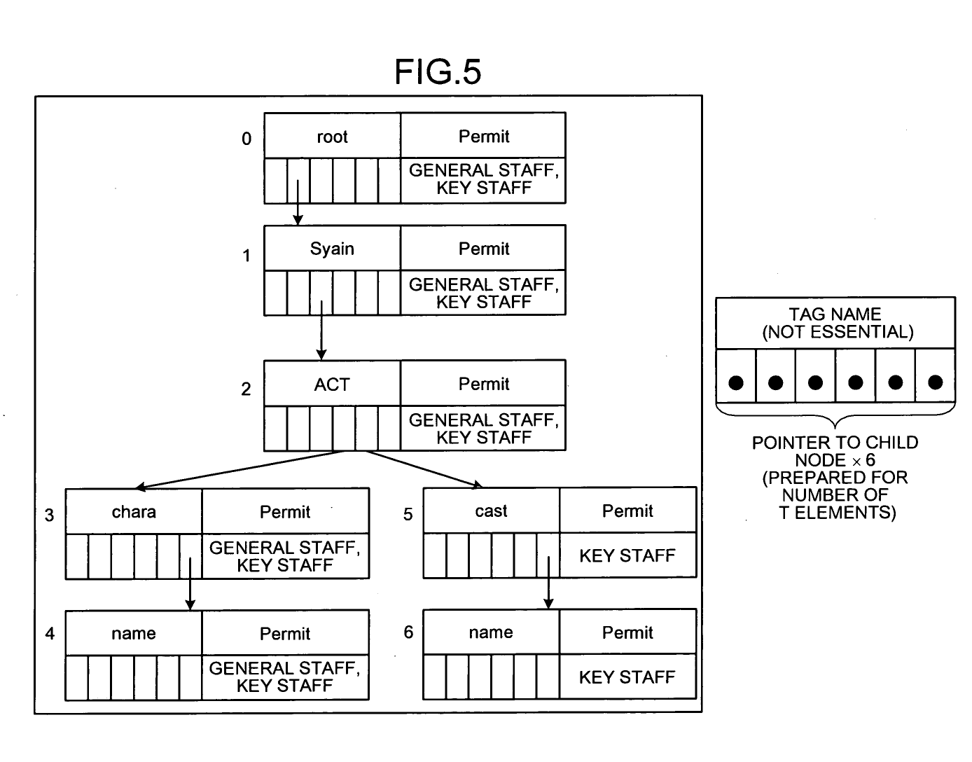

The query controller also stores user information for specifying a user whose access to a node is permitted or denied in an access control DB in association with each other, for each node of the path try corresponding to the XML data. As a specific example, the access control DB stores “/root”, “/root/Syain”, “/root/Syain/ACT/cast”, and the like as nodes of the path try corresponding to the XML data, and stores “Permit” that permits an access for each node. For example, “/root, general staff, key staff”, “/root/Syain, general staff, key staff”, and “/root/Syain/ACT/cast, key staff” are stored in the access control DB (see FIG. 5). In other words, the access control DB is a database in which access control information indicating access permit or access deny is added to the path try.

Under such a circumstance, the user device transmits a query request and an identification number to the database system based on an instruction of the user (see FIG. 1 (1)). As a specific example, the user device transmits [“For $n in //name”, “Return $n/text”] and an ID (011) as a query request (for example, as XQuery or XPath) to the database system.

Upon reception of the query request and an identifier, the query controller in the database system expands a path pattern including a wild card character from the query request to a specific path, to acquire user information corresponding to the identifier from the user information DB, determines whether an access to a node corresponding to the query request by the user specified by the user information is permitted or denied by referring to the access information relative to each node stored in the access control DB, and extracts the access-permitted query request (see FIG. 1 (2)).

The above example is specifically explained here. Upon reception of the query request [“For $n in //name”, “Return $n/text”] and the identification number “ID (011)” from the user device, the query controller expands the path pattern including the wild card character from the query request to specific paths “Q1(/root/Syain/ACT/chara/name)” and “Q2(/root/Syain/ACT/cast/name)”. The query controller then determines that the user who has transmitted the query request is a “general staff”, based on the received ID (011) and the user information “(0**, general staff), (1**, key staff)” stored in the user information DB. Subsequently, the query controller determines whether “Q1” and “Q2” are accessible by the user. In this example, the query controller extracts “Q1(/root/Syain/ACT/chara/name)” as an access-permitted query request, because users whose access to the path (Q1) “/root/Syain/ACT/chara/name” is permitted are “general staff, key staff” and users whose access to the path (Q2) “/root/Syain/ACT/cast/name” is permitted are “key staff”. That is, the expanded query request “Q2” is a path not accessible by the general staff, and therefore the query request “Q2” is discarded here.

The query controller transfers only the extracted query request to the XML database, and the XML database transmits a query response relative to the received query request to the user device (see FIG. 1 (3) and (4)). As a specific example, the query controller transfers “Q1 (/root/Syain/ACT/chara/name)”, which is the extracted query request, to the XML database. Upon reception of the transferred query request “Q1 (/root/Syain/ACT/chara/name)”, the XML database transmits “Sigma Red, Sigma Blue, Sigma Pink” to the user device as a query response matching the query request “Q1 (/root/Syain/ACT/chara/name)”.

Thus, the query controller according to the first embodiment can directly access only to the access control rule related to the query request by referring to the path try, upon reception of any query request (XQuery). Further, the query controller can perform access control by rewriting a query request with a small data amount based on the access control, without requiring a huge memory or disk for reading all the path tries. As a result, the query controller can respond to the query request (XQuery) at a high speed and can operate in a sufficiently small memory area and disk area, as the major characteristic.

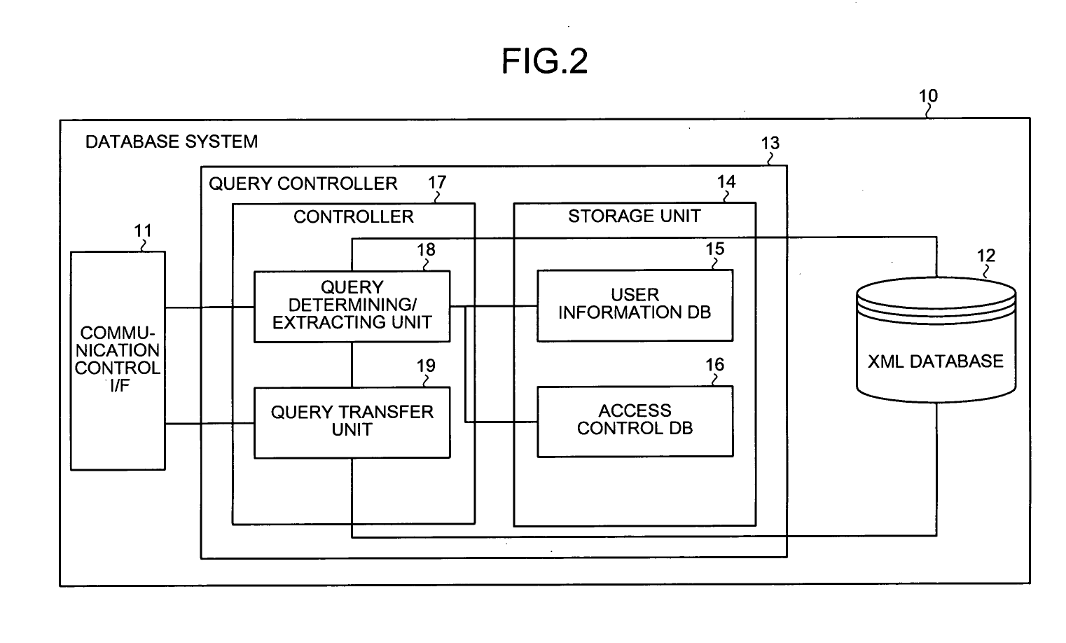

The configuration of the database system shown in FIG. 1 is explained with reference to FIG. 2. FIG. 2 is a block diagram of the configuration of the database system including the query controller according to the first embodiment.

As shown in FIG. 2, a database system 10 includes a communication control interface (I/F) 11, an XML database 12, and a query controller 13. The communication control I/F 11 controls communication of various types of information transferred between the database system 10 and other devices connected to the database system 10. As a specific example, the communication control I/F 11 receives query requests from the user devices and transmits query responses output from the XML database 12 to the user devices.

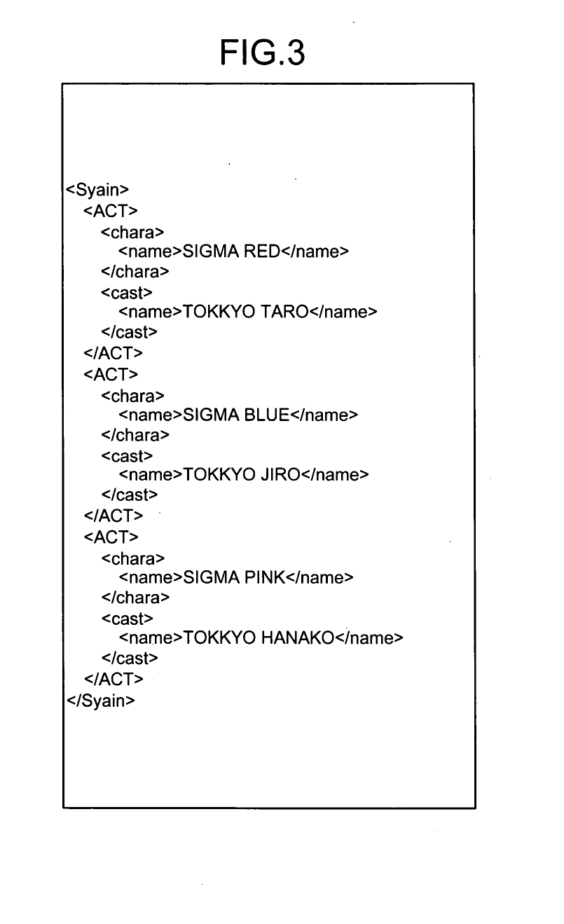

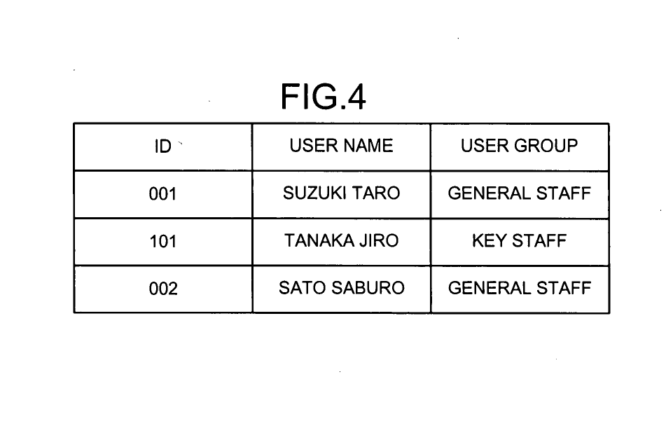

The XML database 12 can store the XML data in the original format, and transmits data matching the received query request to the user (user device) as a search result (query response), by searching the stored XML data. As a specific example, the XML database 12 stores the XML data in the original format as shown in FIG. 3. The XML database 12 acquires “Sigma Red, Sigma Blue, Sigma Pink” from data corresponding to the received query request (“Q2(/root/Syain/ACT/cast/name)” (see FIG. 4) and transmits the data to the user device as a query response. FIG. 3 is an example of information stored in the XML database.

The query controller 13 transfers the query request transmitted from the user device to the XML database 12, and particularly, has a storage unit 14 and a controller 17 as parts closely related to the present invention. The storage unit 14 stores data and programs required for various types of processing by the controller 17, and includes a user information DB 15, and an access control DB 16 as parts closely related to the present invention.

The user information DB 15 stores user information related to the user device in association with the identifier allocated to the user device. As a specific example, as shown in FIG. 4, the user information DB 15 stores “001, Suzuki Taro, general staff”, “101, Tanaka Jiro, key staff”, and the like as “ID” indicating the identifier allocated to the user device, “user name” as a user name of the user device, and “user group” indicating a group to which the user belongs. Information including various data and parameters stored in the user information DB can be optionally changed, unless otherwise specified. FIG. 4 is an example of the information stored in the user information DB.

The access control DB 16 stores user information for specifying a user whose access to a node is permitted or denied in association with each node of the path try corresponding to the XML data. As a specific example, as shown in FIG. 5, the access control DB 16 stores “/root”, “/root/Syain”, “/root/Syain/ACT/cast”, and the like as nodes of the path try corresponding to the XML data, and stores “Permit” that permits an access for each node. For example, “/root, general staff, key staff”, “/root/Syain, general staff, key staff”, and “/root/Syain/ACT/cast, key staff” are stored in the access control DB (see FIG. 5). In other words, the access control DB 16 is a database in which the path try is added with access control information indicating access permit or access deny. Information including various data and parameters to be stored in the user information DB can be optionally changed, unless otherwise specified. FIG. 5 is an example of information stored in the access control DB.

The controller 17 has an internal memory for storing control programs such as an operating system (OS), programs that specify various process procedures, and necessary data, and includes a query determining/extracting unit 18 and a query transfer unit 19 as parts closely related to the present invention, to execute various types of processing.

The query determining/extracting unit 18 expands a path pattern including a wild card character from the query request to specific paths, upon reception of the query request together with an identifier, to acquire user information corresponding to the identifier from the user information DB 15, determines whether an access to a node corresponding to the query request by the user specified by the user information is permitted or denied by referring to the access information relative to each node stored in the access control DB 16, and extracts the access-permitted query request.

As a specific example, upon reception of a query request [“For $n in //name”, “Return $n/text”] and the identification number “ID (011)” from the user device, the query determining/extracting unit 18 expands the path pattern including the wild card character from the query request to specific paths “Q1(/root/Syain/ACT/chara/name)” and “Q2(/root/Syain/ACT/cast/name)”. The query controller then determines that the user who has transmitted the query request is a “general staff”, based on the received ID (011) and the user information “(0**, general staff), (1**, key staff)” stored in the user information DB. Subsequently, the query controller determines whether “Q1” and “Q2” are accessible by the user. In this example, the query determining/extracting unit 18 extracts “Q2(/root/Syain/ACT/cast/name)” as an access-permitted query request, because users whose access to the path (Q1) “/root/Syain/ACT/chara/name” is permitted are “general staff, key staff” and users whose access to the path (Q2) “/root/Syain/ACT/cast/name” is permitted are “key staff”.

When the wild card is not included in the received query request, the query determining/extracting unit 18 acquires the user information corresponding to the identifier from the user information DB 15, determines whether an access to a node corresponding to the query request by the user specified by the user information is permitted or denied by referring to the access information relative to each node stored in the access control DB 16, and extracts the access-permitted query request. As a specific example, when “Q2(/root/Syain/ACT/cast/name)” as a query request and identification number “011” are received, the query determining/extracting unit 18 determines that the user device is “general staff” from the identification number “011”, and then determines whether the received “Q2” is accessible by the “general staff”. In this case, because the query request “Q2” is accessible, the query determining/extracting unit 18 extracts “Q2(/root/Syain/ACT/cast/name)”.

The query transfer unit 19 transfers only the query request extracted by the query determining/extracting unit 18 to the XML database 12. Specifically in the above example, upon reception of a query request [“For $n in //name”, “Return $n/text”] and the identification number “ID (011)” from the user device, the query transfer unit 19 transfers only “Q2(/root/Syain/ACT/cast/name)”, which is the query request extracted by the query determining/extracting unit 18, to the XML database 12.

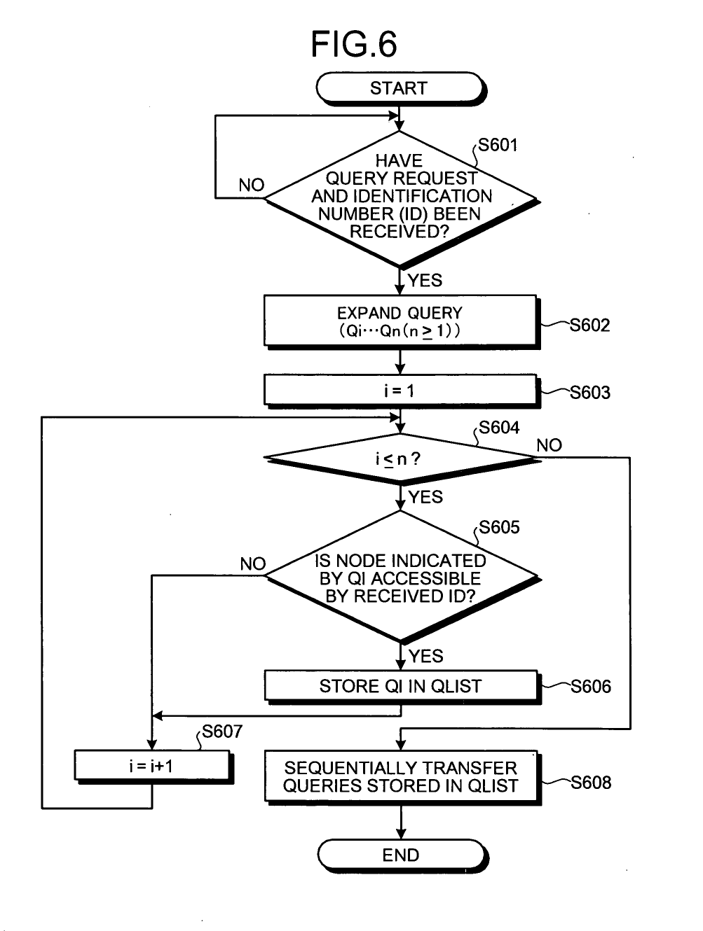

The process by the database system is explained with reference to FIG. 6. FIG. 6 is a flowchart for explaining a query response process in the database system according to the first embodiment.

As shown in FIG. 6, upon reception of a query request and the identification number (ID) from the user device (YES at step S601), the query determining/extracting unit 18 expands the path pattern including the wild card character from the query request to specific paths (step S602). As a specific example, the query determining/extracting unit 18 expands the path pattern including the wild card character from the query request to specific paths “Qi, . . . , Qn (n≧1).

Subsequently, the query determining/extracting unit 18 assigns “1” to “i” (step S603), to determine whether “i” is equal to or less than “n” (step S604). When “i” is equal to or less than “n”, the query determining/extracting unit 18 determines whether a node indicated by “Qi” is accessible by the received ID (step S605).

When the node indicated by “Qi” is accessible by the received ID (YES at step S605), the query determining/extracting unit 18 stores “Qi” in a QList (step S606), and increments “i” by “1” (step S607).

On the other hand, when the node indicated by “Qi” is not accessible by the received ID (NO at step S605), the query determining/extracting unit 18 increments “i” by “1” without storing “Qi” in the QList (step S607).

Thereafter, when “i” is incremented by “1”, the query determining/extracting unit 18 returns to step S604, to repeat the process from steps S604 to S607 until “i” exceeds “n”.

When “i” exceeds “n” (NO at step S604), the query transfer unit 19 transfers queries stored in the QList sequentially to the XML database 12 (step S608).

According to the first embodiment, the user information of the user device is stored in association with the identifier allocated to the user device, and the user information specifying the user whose access to a node is permitted or denied is stored in association with each node of the path try corresponding to the XML data. When a query request is received together with the identifier, user information corresponding to the identifier is acquired from the user information DB, it is determined whether an access to the node corresponding to the query request by the user specified by the user information is permitted or denied by referring to the access information relative to each node stored in the access control DB, to extract an access-permitted query request, and only the extracted query request is transferred to the XML database 12. Accordingly, at the time of response to the query request (XQuery), the query controller can respond to the query request (XQuery) at a high speed and can operate in a sufficiently small memory area and disk area.

For example, upon reception of any query request (XQuery), the query controller can directly access only to the access control rule related to the query request by referring to the path try. The query controller can perform access control by rewriting a query request with a small data amount based on the access control, while requiring only a small memory or disk for reading all the path tries. As a result, the query controller can respond to the query request (XQuery) at a high speed and can operate in a sufficiently small memory area and disk area.

According to the first embodiment, upon reception of a query request together with the identifier, the query controller expands the path pattern including the wild card character from the query request to specific paths, to acquire user information corresponding to the identifier from the user information DB, determines whether an access to a node corresponding to the query request by the user specified by the user information is permitted or denied by referring to the access information relative to each node stored in the access control DB, and extracts the access-permitted query request. Accordingly, at the time of response to the query request (XQuery), the query controller can respond to the query request (XQuery) at a high speed and can operate in a sufficiently small memory area and disk area.

For example, the query request including the wild card is expanded beforehand, and only a query request for which an access is permitted is extracted. Therefore, high-speed response is possible and operation in a smaller memory area and disk area is possible, as compared to a case that the query request including the wild card is transferred to the XML database without expanding the query request.

According to the first embodiment, a case that the access control DB is prestored has been explained. However, the present invention is not limited thereto, and the access control DB can be generated automatically.

Therefore, in a second embodiment of the present invention, a case that the access control DB is generated automatically is explained. According to the second embodiment, the configuration and a process flow of the database system according to the second embodiment, and effects of the second embodiment are explained.

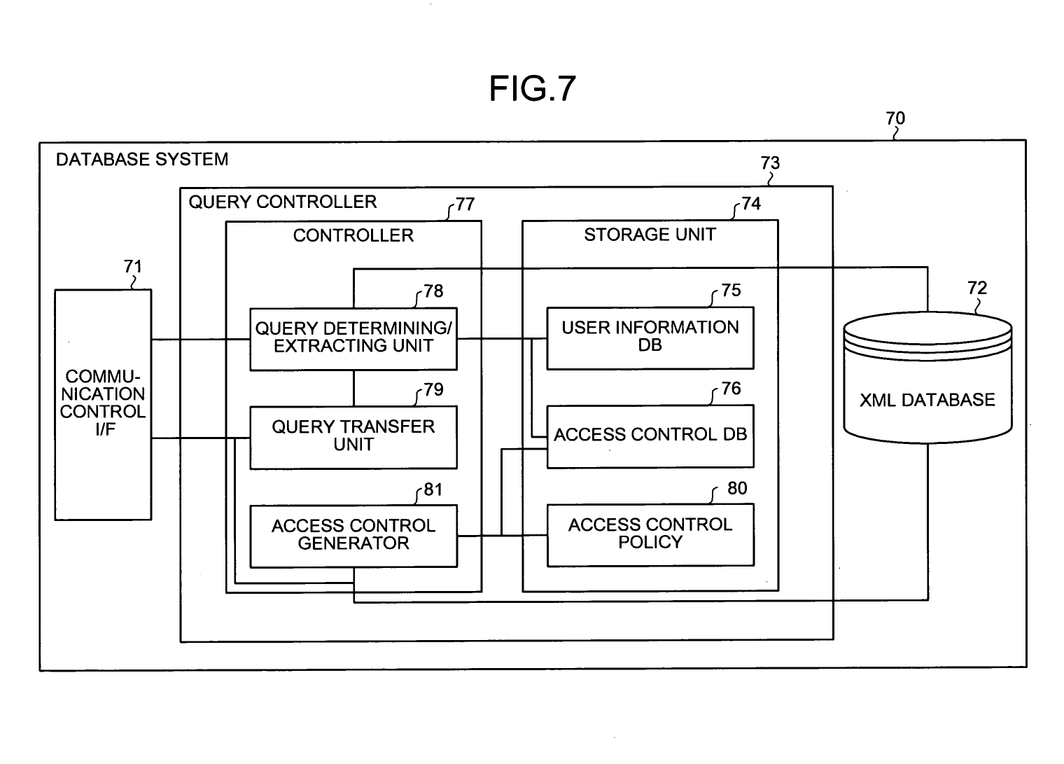

The configuration of the database system according to the second embodiment is explained with reference to FIG. 7. FIG. 7 is a block diagram of the configuration of the database system including the query controller according to the second embodiment.

As shown in FIG. 7, a database system 70 includes a communication control I/F 71, an XML database 72, and a storage unit 74 and a controller 77 in a query controller 73. The communication control I/F 71, the XML database 72, a user information DB 75 and an access control DB 76 in the storage unit 74, and a query determining/extracting unit 78 and a query transfer unit 79 in the controller 77 respectively have the same function as that of the communication control I/F 11, the XML database 12, the user information DB 15 and the access control DB 16 in the storage unit 14, and the query determining/extracting unit 18 and the query transfer unit 19 in the controller 17 explained in FIG. 2. Therefore, detailed explanation thereof is omitted. An access control policy 80 and an access control generator 81 having a different function from the first embodiment are explained.

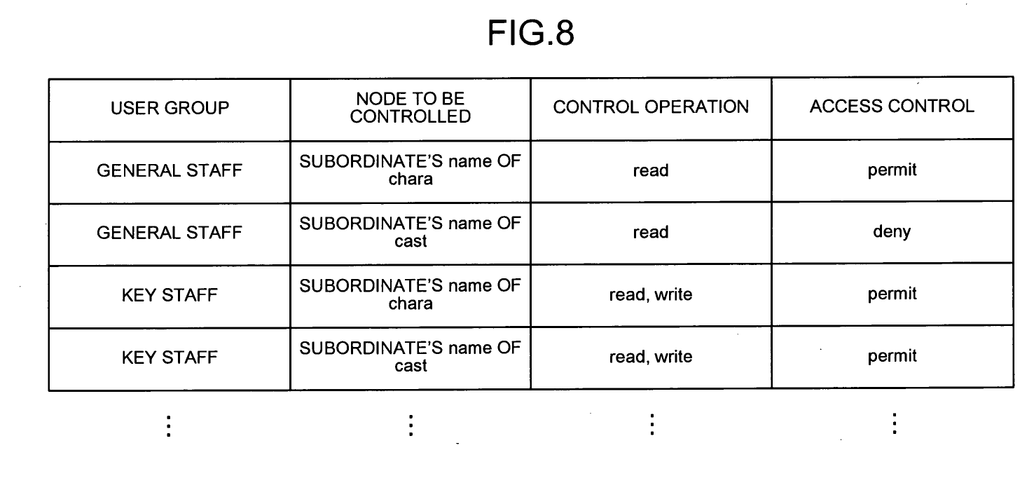

The access control policy 80 stores the user information, a node to be controlled indicating each node of the XML data, a control process content indicating a process content relative to the node to be controlled, and an access control content indicating whether to permit or deny the control process content in association with each other. For example, as shown in FIG. 8, “general staff, subordinate's name of chara, read, permit”, “general staff, subordinate's name of cast, read, deny” and “key staff, subordinate's name of chara, read, write, permit” are stored as “user group” indicating the user information, “node to be controlled” indicating the node to be controlled, “control operation” indicating the control process content, and “access control” indicating the access control information. The storage format explained here is only an example and does not limit the storage format, and for example, the data can be described in extensible access control markup language (XACML). Information including various data and parameters can be optionally changed, unless otherwise specified. FIG. 8 is an example of information that can be stored in the access control policy.

The access control generator 81 stores the user information for specifying the user whose access to the node is permitted or denied for each node of the path try corresponding to the XML data in association with each other based on the access control policy 80. As a specific example, the access control generator 81 generates access control as shown in FIG. 5 from the access control policy stored in the access control policy 80 and the path try in association with the user information for specifying the user whose access to the node is permitted or denied, and stores the access control in the access control DB.

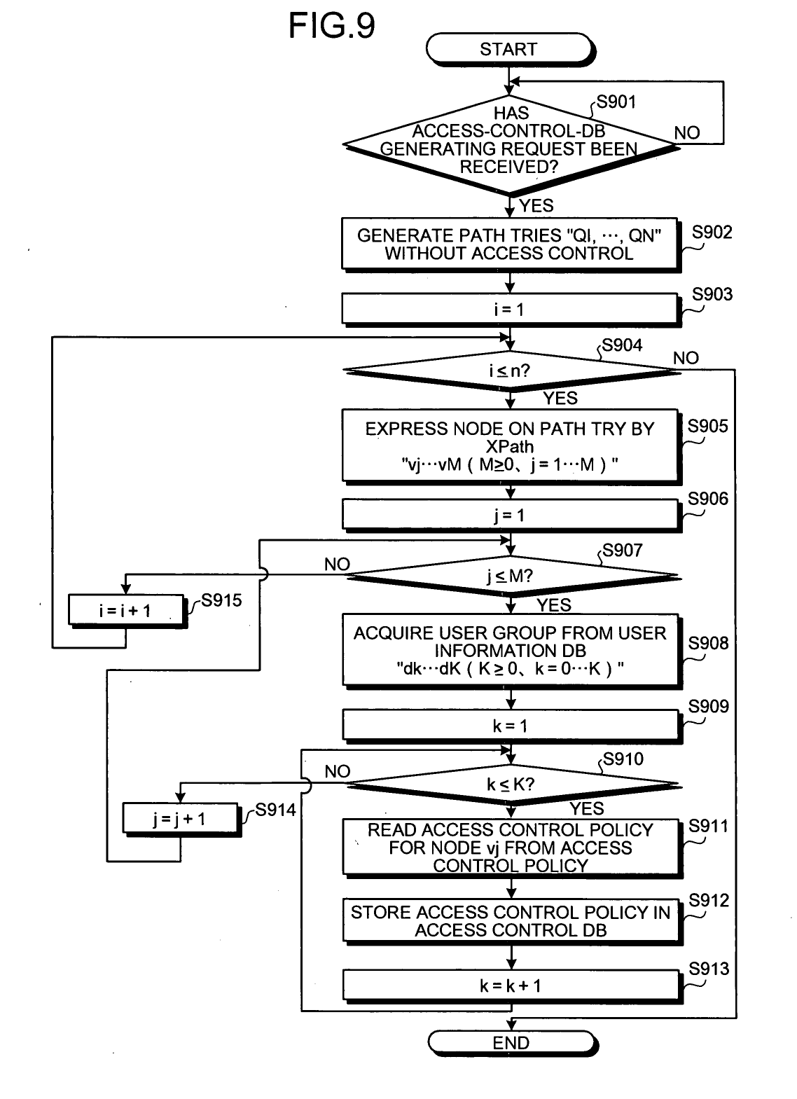

A process by the database system is explained with reference to FIG. 9. FIG. 9 is a flowchart for explaining an access-control-DB generating process flow in the database system according to the second embodiment.

As shown in FIG. 9, upon reception of an access-control-DB generating request (YES at step S901), the access control generator 81 in the query controller creates path tries “Q1, . . . , Qn” without access control (step S902).

Subsequently, the access control generator 81 in the query controller assigns “1” to “i” (step S903), to determine whether “i” is equal to or less than “n” (step S904). When “i” is equal to or less than “n” (YES at step S904), the access control generator 81 expresses the node on the path try by XPath as “vj, . . . , vM (M≧0, j=0, . . . M)” (step S905).

Subsequently, the access control generator 81 assigns “1” to “j” (step S906), to determine whether “j” is equal to or less than “M” (step S907). When “j” is equal to or less than “M” (YES at step S907), the access control generator 81 acquires a user group (dk, . . . , dK (K≧0, k=0 . . . K) from the user information DB (step S908) and assigns “1” to “k” (step S909). The access control generator 81 then determines whether “k” is equal to or less than “K” (step S910).

When “k” is equal to or less than “K” (YES at step S910), the access control generator 81 reads the access control policy for node vj from the access control policy (step S911) to store the access control policy in the access control DB (step S912), and increments “k” by “1” (step S913).

Thereafter, the access control generator 81 returns to step S910 to repeat the process from steps S911 to S913, while “k” is equal to or less than “K”. When “k” exceeds “K” (NO at step S910), the access control generator 81 increments “j” by “1” (step S914), to return to step S907.

The access control generator 81 then repeats the process from steps S907 to S914, while “j” is equal to or less than “M”. When “j” exceeds “M” (NO at step S907), the access control generator 81 increments “i” by “1” (step S915), and repeats the process from steps S904 to S915, while “i” is equal to or less than “n”. When “i” exceeds “n” (NO at step S904), the access control generator 81 finishes the process.

According to the second embodiment, when the access control policy, in which the user information, the nodes to be controlled indicating respective nodes of the XML data, the control process content indicating the process content relative to the nodes to be controlled, and the access control content indicating whether to permit or deny the control process content are associated with each other, is received, the user information for specifying the user whose access to the node is permitted or denied is stored in the access control DB in association with each node of the path try corresponding to the XML data based on the access control policy. Accordingly, even when the access control policy is changed, the path try is automatically generated. As a result, a burden on the user (database administrator) can be reduced, and access control according to a new access control policy can be performed quickly.

For example, even when personnel reshuffle or organization change occurs, a new path try can be automatically generated only by describing this matter in the access policy without requiring manual correction of the path try. As a result, burden on the user (database administrator) can be reduced, and access control according to the new access control policy can be performed quickly.

According to the second embodiment, a case that one access control DB is generated from one XML database has been explained, however, the present invention is not limited thereto, and one access control DB can be generated from a plurality of XML databases.

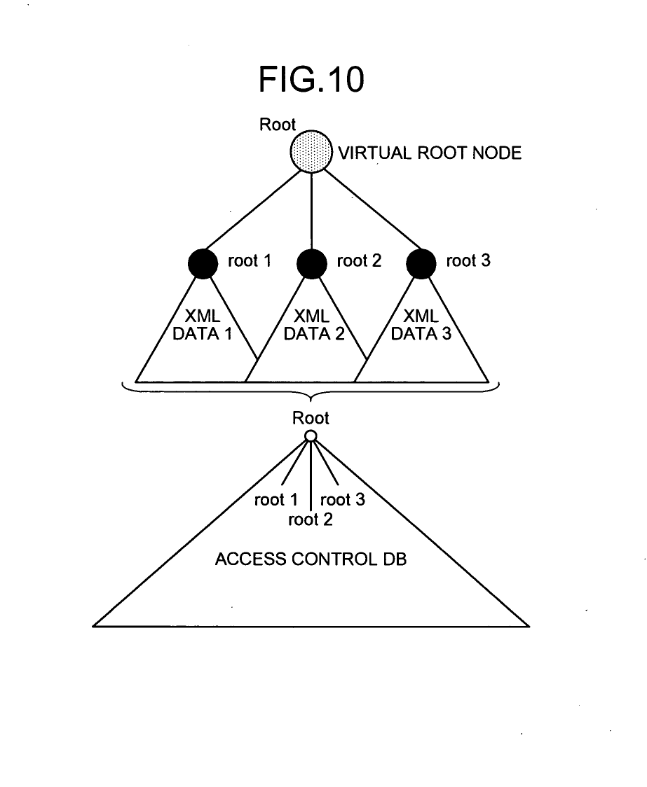

As a specific example, for example, as shown in FIG. 10, when there are XML database 1 (top-level node: root 1), XML database 2 (top-level node: root 2), XML database 3 (top-level node: root 3), respective path tries need to be generated, because a starting point of each path is different. However, by generating a “node: Root” at an upper position than the respective top-level nodes, the starting point becomes “Root” relative to all databases, and path expression starting from the “Root” can be given for the nodes in respective databases. As a result, one access control DB can be generated from a plurality of XML databases. FIG. 10 is an example in which one access control DB is generated from a plurality of XML databases.

Accordingly, one path try can be generated, assuming a plurality of XML databases as one large database. As a result, wasteful use of the memory area and the disk area can be prevented, as compared to a case that the path tries are generated for the number of XML databases.

The first to the third embodiments have been explained above; however, the present invention can be embodied in various different embodiments other than the ones explained. Therefore, a different embodiment is explained, dividing the explanation into (1) system configuration and the like, and (2) program.

The respective constituent elements of the respective devices shown in the drawings are functionally conceptual, and physically the same configuration is not always necessary. In other words, the specific mode of dispersion and integration of the devices is not limited to the shown ones, and all or a part thereof can be functionally or physically dispersed or integrated in an optional unit, according to various kinds of load and the status of use (for example, integrating the query determining/extracting unit and the query transfer unit). All or an optional part of various process functions performed by the respective devices can be realized by a central processing unit (CPU) or a program analyzed and executed by the CPU, or can be realized as hardware by the wired logic.

Among the respective process explained in the embodiments, all or a part of the process explained as being performed automatically (for example, query response) can be performed manually, or all or a part of the process explained as being performed manually can be performed automatically in a known method. In addition, information (for example, FIGS. 3, 4, 5, and 8) including the process procedures, the control procedures, specific names, and various kinds of data and parameters shown in the present specification or the drawings can be optionally changed unless otherwise specified.

Various processes explained in the embodiments can be realized by executing pre-prepared programs by a computer system such as a personal computer or a workstation. Therefore, a computer system that executes programs having the same functions as in the embodiments is explained as another embodiment.

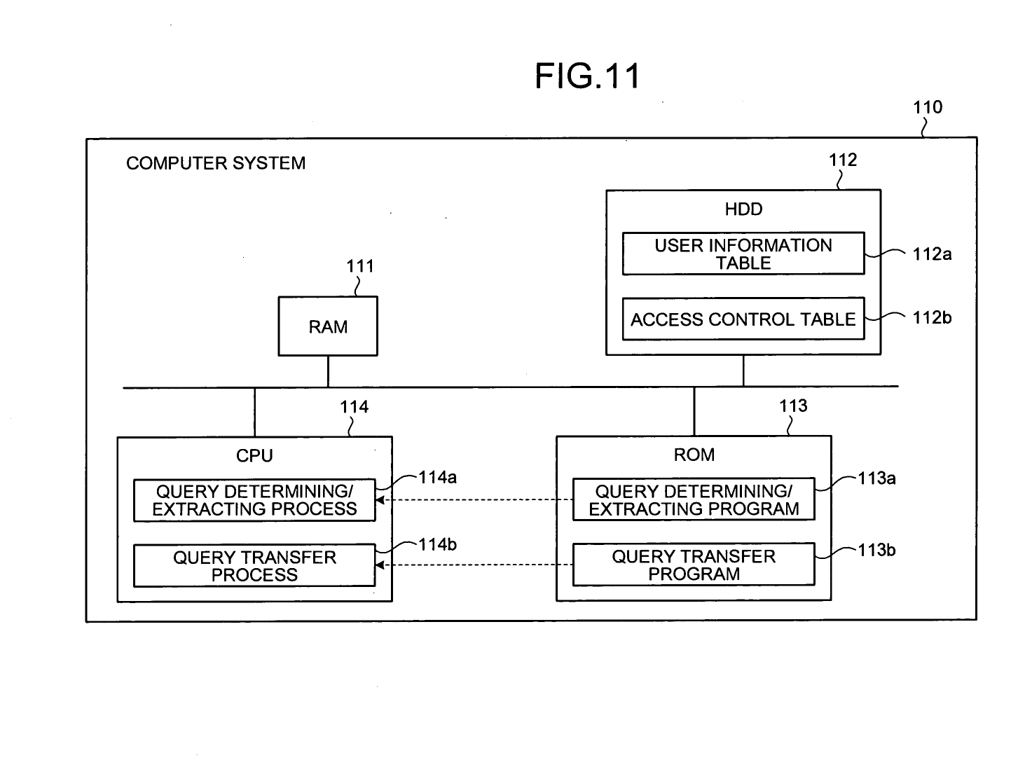

FIG. 11 is an example of the computer system that executes the query control program. As shown in FIG. 11, a computer system 110 includes a random access memory (RAM) 111, a hard disk drive (HDD) 112, a read only memory (ROM) 113, and a CPU 114. As shown in FIG. 11, programs demonstrating the same functions as in the embodiments, that is, a query determining/extracting program 113a and a query transfer program 113b are pre-stored in the ROM 113.

The programs 113a and 113b are read and executed by the CPU 114 to become a query determining/extracting process 114a and a query transfer process 114b. The query determining/extracting process 114a corresponds to the query determining/extracting unit 18 shown in FIG. 2. The query transfer process corresponds to the query transfer unit 19.

A user information table 112a for storing the user information of the user device in association with the identifier allocated to the user device, and an access control table 112b for storing the user information for specifying the user whose access to the node is permitted or rejected in association with each node of the path tray corresponding to the XML data are provided in the HDD 112. The user information table 112a corresponds to the user information DB 15 shown in FIG. 2, and the access control table 112b corresponds to the access control DB 16.

The programs 113a and 113b are not necessary stored in the ROM 113. For example, the programs 113a and 113b can be stored in a “portable physical medium” such as a flexible disk (FD), a compact disk-ROM (CD-ROM), a magneto optical (MO) disk, a digital versatile disk (DVD disk), or IC card inserted into the computer system 110, a “fixed physical medium” such as a HDD equipped in or out of the computer system 110, or “another computer system” connected to the computer system 110 via a public line, the Internet, a local area network (LAN), or a wide area network (WAN), so that these programs are read therefrom and executed by the computer system 110.

As described above, according to one aspect of the present invention, at the time of response to the query request (XQuery), the query controller can respond to the query request (XQuery) at a high speed and can operate in a very small memory area and disk area.

For example, upon reception of any query request (XQuery), the query controller can directly access only to the access control rule related to the query request by referring to the path try. The query controller can perform access control by rewriting a query request with a small data amount based on the access control, while requiring only a small memory or disk for reading all the path tries. As a result, the query controller can respond to the query request (XQuery) at a high speed and can operate in a sufficiently small memory area and disk area.

Furthermore, according to another aspect of the present invention, at the time of response to the query request (XQuery), the query controller can respond to the query request (XQuery) at a higher speed and can operate in a sufficiently small memory area and disk area.

For example, the query request including the wild card is expanded beforehand, and only an access-permitted query request is extracted. Therefore, high-speed response is possible and operation in a smaller memory area and disk area is possible, as compared to a case that the query request including the wild card is transferred to the XML database without expanding the query request.

Moreover, according to another aspect of the present invention, even if the access control policy is changed, a path try can be automatically generated. As a result, burden on the user (database administrator) can be reduced, and access control according to the new access control policy can be performed quickly.

For example, even when personnel reshuffle or organization change occurs, a new path try can be automatically generated only by describing this matter in the access policy without requiring manual correction of the path try. As a result, burden on the user (database administrator) can be reduced, and access control according to the new access control policy can be performed quickly.

Furthermore, according to another aspect of the present invention, one path try can be generated, assuming a plurality of XML databases as one large database. As a result, wasteful use of the memory area and the disk area can be prevented, as compared to a case that the path tries are generated for the number of XML databases.

For example, when there are XML database 1 (top-level node: root 1), XML database 2 (top-level node: root 2), XML database 3 (top-level node: root 3), respective path tries need to be generated, because a starting point of each path is different. However, by generating the “node: Root” at an upper position than the respective top-level nodes, the starting point becomes “Root” relative to all databases, and path expression starting from the “Root” can be given for the nodes in respective databases. As a result, wasteful use of the memory area and the disk area can be prevented, as compared to a case that the path tries are generated for the number of XML databases.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A computer-readable recording medium that stores therein a computer program for transferring a query request transmitted from a user device that performs various processes to an extensible-markup-language database that responds to the query request, the computer program causing a computer to execute:
first storing including storing user information on the user device in association with an identifier allocated to the user device;
second storing including storing user information for specifying a user whose access to a node is permitted or denied for each node of a path try corresponding to the extensible-markup-language data stored in the extensible-markup-language database;
query determining/extracting including, upon receiving the identifier and the query request,
acquiring user information corresponding to the identifier,
determining whether an access to a node corresponding to the query request by the user specified by the user information is permitted or denied by referring to access information with respect to each stored node, and
extracting a query request for which the access is permitted; and
transferring the query request extracted at the query determining/extracting.

2. The computer-readable recording medium according to claim 1, wherein the query determining/extracting includes expanding a path pattern including a wild card character from the query request to a specific path.

3. The computer-readable recording medium according to claim 1, wherein the computer program further causes the computer to execute storing, upon receiving an access control policy in which the user information, a control target node indicating each node of the extensible-markup-language data, a control process content indicating a process content with respect to the control target node, and an access control content indicating whether to permit or deny the control process content are associated with each other, the user information for each node of the path try based on the access control policy.

4. The computer-readable recording medium according to claim 1, wherein the second storing includes
generating a tentative node positioned at a higher position than a top-level node of each extensible-markup-language data with respect to a plurality of extensible-markup-language data, and
storing the user information for each node of the extensible-markup-language data in which a top-level node of each of the extensible-markup-language data storing the user information for specifying a user whose access to the node is permitted or denied is taken as the tentative node.

5. An apparatus for transferring a query request transmitted from a user device that performs various processes to an extensible-markup-language database that responds to the query request, the apparatus comprising:
a user-information storage unit that stores user information on the user device in association with an identifier allocated to the user device;
an access-control storage unit that stores user information for specifying a user whose access to a node is permitted or denied for each node of a path try corresponding to the extensible-markup-language data stored in the extensible-markup-language database;
a query determining/extracting unit that, upon receiving the identifier and the query request, acquires user information corresponding to the identifier from the user-information storage unit, determines whether an access to a node corresponding to the query request by the user specified by the user information is permitted or denied by referring to access information with respect to each node stored in the access-control storage unit, and extracts a query request for which the access is permitted; and
a query transfer unit that transfers the query request extracted by the query determining/extracting unit.

6. The apparatus according to claim 5, wherein the query determining/extracting unit expands a path pattern including a wild card character from the query request to a specific path.

7. The apparatus according to claim 5, further comprising an access-control generating unit that, upon receiving an access control policy in which the user information, a control target node indicating each node of the extensible-markup-language data, a control process content indicating a process content with respect to the control target node, and an access control content indicating whether to permit or deny the control process content are associated with each other, stores the user information for each node of the path try based on the access control policy.

8. The apparatus according to claim 5, wherein the access-control storage unit generates a tentative node positioned at a higher position than a top-level node of each extensible-markup-language data with respect to a plurality of extensible-markup-language data, and stores the user information for each node of the extensible-markup-language data in which a top-level node of each of the extensible-markup-language data storing the user information for specifying a user whose access to the node is permitted or denied is taken as the tentative node.

9. A method of transferring a query request transmitted from a user device that performs various processes to an extensible-markup-language database that responds to the query request, the method comprising:
first storing including storing user information on the user device in association with an identifier allocated to the user device;
second storing including storing user information for specifying a user whose access to a node is permitted or denied for each node of a path try corresponding to the extensible-markup-language data stored in the extensible-markup-language database;
query determining/extracting including, upon receiving the identifier and the query request,
acquiring user information corresponding to the identifier,
determining whether an access to a node corresponding to the query request by the user specified by the user information is permitted or denied by referring to access information with respect to each stored node, and
extracting a query request for which the access is permitted; and
transferring the query request extracted at the query determining/extracting.

10. The method according to claim 9, wherein the query determining/extracting includes expanding a path pattern including a wild card character from the query request to a specific path.

11. The method according to claim 9, further comprising storing, upon receiving an access control policy in which the user information, a control target node indicating each node of the extensible-markup-language data, a control process content indicating a process content with respect to the control target node, and an access control content indicating whether to permit or deny the control process content are associated with each other, the user information for each node of the path try based on the access control policy.

12. The method according to claim 9, wherein the second storing includes
generating a tentative node positioned at a higher position than a top-level node of each extensible-markup-language data with respect to a plurality of extensible-markup-language data, and
storing the user information for each node of the extensible-markup-language data in which a top-level node of each of the extensible-markup-language data storing the user information for specifying a user whose access to the node is permitted or denied is taken as the tentative node.
